(19) United States
(12) Patent Application Publication
(10) Pub. No.: US 2025/0282420 A1
(43) Pub. Date: Sep. 11, 2025

(54) POSITION DETECTION DEVICE AND DETECTION DEVICE

(71) Applicant: Proterial, Ltd., Tokyo (JP)

(72) Inventors: Chiaki SUGIMOTO, Tokyo (JP); Sachio SUZUKI, Tokyo (JP); Masanori SAGAWA, Tokyo (JP)

(73) Assignee: Proterial, Ltd., Tokyo (JP)

(21) Appl. No.: 19/054,110

(22) Filed: Feb. 14, 2025

(30) Foreign Application Priority Data
Mar. 7, 2024 (JP) 2024-034641

(51) Int. Cl. B62D 15/02; G01D 5/20

(52) U.S. Cl. CPC B62D 15/0225; G01D 5/2053; G01D 2205/18

(57) ABSTRACT

A position detection device for detecting the position of a rack shaft that steers the steering wheel of a vehicle by moving in the axial direction, includes a cylindrical rack housing that houses the rack shaft, a detector that detects the position of the rack shaft relative to the rack housing, a support member that supports the detector relative to the rack housing, and a seal member attached to the support member, wherein the rack housing has a through-hole that penetrates between the inner and outer circumference surfaces along the radial direction of the rack shaft. The support member has a support portion that is positioned in the through-hole to support the detector and a fixing portion that is fixed to the rack housing, and the seal member is in elastic contact with the outer surface of the support portion and the inner surface of the through-hole.

### CROSS-REFERENCE TO RELATED APPLICATIONS

The present patent application claims the priority of Japanese patent application No. 2024-34641 filed on Mar. 7, 2024, the entire contents of which are incorporated herein by reference.

### TECHNICAL FIELD

This invention relates to a position detection device for detecting the position of a rack shaft of a vehicle and a detection device for detecting a physical quantity.

### BACKGROUND OF THE INVENTION

As a position detection device for detecting the position of a rack shaft of a vehicle, the applicant of the present application has proposed the one described in Patent Literature 1. The position detection device described in Patent Literature 1 has a target made of high permeability material or high conductivity material fixed to the rack shaft, an excitation coil that generates an alternating magnetic field, and a detection coil with which the magnetic flux of the alternating magnetic field generated by the excitation coil chains. The excitation coil and detection coil are formed on a single substrate and extend along the axial direction of the rack shaft. The substrate is fixed to the lid of the rack housing, which has a metal body and a plastic lid. When the position of the target relative to the substrate changes as the rack shaft moves, the intensity of the magnetic field detected by the detection coil changes. The substrate corresponds to a detector of the position detection device described in Patent Literature 1.

Also, Patent Literature 2 describes the provision of a breathing valve in the housing of a vehicle steering device to mitigate internal pressure increases. The breathing valve consists of a membrane that allows air and water vapor to pass through, but blocks water droplets.

### PRIOR ART LITERATURE

Citation List Patent Literature 1: JP 2023-174533
Patent Literature 2: JP 2019-044881

### SUMMARY OF THE INVENTION

It is desirable to prevent moisture from entering the rack housing as much as possible in order to prevent rust and other problems. Even in a case where a breathing valve is provided in the steering device as described in Patent Literature 2, for example, it is desirable to prevent water droplets caused by water vapor that has passed through the breathing valve and entered the housing, or other substance, from adhering to the detector.

The present invention was made in view of the above circumstances, and is intended to achieve at least one of the first to third objects described below. The first object is to provide a position detection device capable of positioning a detector for detecting the position of a rack shaft in close proximity to the rack shaft, while still assuring the waterproof property of the rack housing. The second object is to provide a position detection device capable of preventing, for example, water droplets caused by water vapor that has passed through the breathing valve and entered the housing, from adhering to the detector. The third object is to provide a position detection device and a detection device capable of preventing a seal member which is positioned between the inner surface of a through-hole formed in a member to be mounted, such as a rack housing, and the outer surface of a support member supporting a detector, from slipping out.

For solving the aforementioned problem, one aspect of the present invention provides position detection device for detecting a position of a rack shaft that steers a steering wheel of a vehicle by moving in an axial direction, comprising:
a cylindrical rack housing that houses the rack shaft;
a detector that detects the position of the rack shaft relative to the rack housing;
a support member that supports the detector relative to the rack housing; and
a seal member attached to the support member,
wherein the rack housing has a through-hole that penetrates between the inner and outer circumference surfaces along a radial direction of the rack shaft,
wherein the support member has a support portion that is positioned in the through-hole to support the detector and a fixing portion that is fixed to the rack housing, and
wherein the seal member is in elastic contact with an outer surface of the support portion and an inner surface of the through-hole.

Also, for the purpose of solving the aforementioned problem, another aspect of the present invention provides a detection device, comprising:
a support member having a cylindrical portion that is accommodated in a through-hole formed through a member to be mounted;
a detector housed in a housing space of the cylindrical portion and supported by the support member,
a seal member interposed between an inner surface of the through-hole and an outer surface of the support member; and
a sealing member attached to an end of the cylindrical portion to seal the housing space, wherein the sealing member prevents the seal member from slipping out of the cylindrical portion.

### Advantageous Effects of the Invention

According to the present invention, it is possible to achieve at least one of the first to third objects described above.

### BRIEF DESCRIPTION OF THE DRAWINGS

FIG. 1 is a schematic diagram of a vehicle equipped with a steer-by-wire steering device having a stroke sensor as a position detection device according to the first embodiment of the present invention.

FIG. 2 is a cross-sectional view of the steering device taken along the line A-A in FIG. 1.

FIG. 3 is a perspective view of a detection unit, a rack shaft, and a detection target attached to a rack housing.

FIG. 4 is an exploded perspective view of the detection unit.

FIG. 5 is an exploded perspective view of the detection unit.

FIG. 6A and FIG. 6B are cross-sectional views taken along the lines B-B and C-C in FIG. 3 respectively.

FIG. 7 is a cross-sectional view taken along the line D-D in FIG. 3.

FIG. 8A is a plan view showing an example of the wiring patterns of first and third wiring layers of the substrate.

FIG. 8B is a plan view showing an example of the wiring pattern of second and fourth wiring layers of the substrate.

FIG. 9 is a plan view of the wiring patterns of the first, second, third, and fourth wiring layers of the substrate, superimposed on one another.

FIG. 10A and FIG. 10B respectively show before and after laser welding a support member and a sealing member.

FIG. 11 is a cross-sectional view of the seal member in its natural state with no external force acting on it.

FIG. 12 is a cross-sectional view of a hub unit equipped with a detection device according to a second embodiment.

FIG. 13A is a cross-sectional view of the detection device and its periphery.

FIG. 13B is an enlarged partial view of FIG. 13A.

FIG. 14 is a perspective view showing the end of the cylindrical portion in the support member and the sealing member.

### DETAILED DESCRIPTION OF THE INVENTION

### First Embodiment

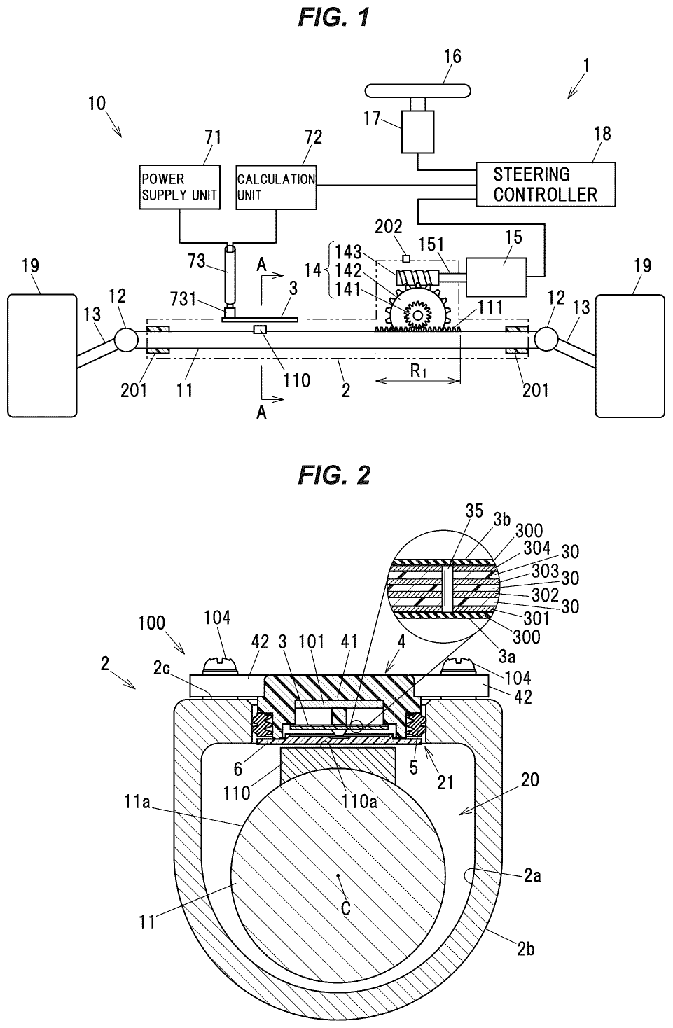

FIG. 1 is a schematic diagram of a vehicle equipped with a steer-by-wire steering device 1 having a stroke sensor 10 as a position detection device according to the first embodiment of the present invention.

As shown in FIG. 1, a steering device 1 includes a stroke sensor 10, a rack shaft 11, ball joints 12 provided at both ends of the rack shaft 11, tie rods 13 connected to the rack shaft 11 via the ball joints 12, a worm reduction mechanism 14 having a pinion gear 141 meshed with the rack teeth 111 of the rack shaft 11, an electric motor 15 providing axial movement force to the rack shaft 11 via the worm reduction mechanism 14, a steering wheel 16 operated by the driver, a steering angle sensor 17 detecting a steering angle of the steering wheel 16, and a steering controller 18 that controls the electric motor 15 based on the steering angle detected by the steering angle sensor 17. The rack shaft 11 steers the left and right steering wheels 19 (front wheels) by moving in the axial direction. The stroke sensor 10 detects the position of the rack shaft 11 in the vehicle width direction.

The rack shaft 11 is housed in a cylindrical rack housing 2 fixed to the car body and supported by a pair of rack bushings 201 located at both ends of the rack housing 2. In FIG. 1, the rack housing 2 is shown in two-dotted lines, and the rack shaft 11 and the worm reduction mechanism 14 inside the rack housing 2 are shown in solid lines. The rack housing 2 is equipped with a breathing valve 202 that allows air and water vapor to pass into and out of the rack housing 2, but blocks water droplets. The worm reduction mechanism 14 has a worm wheel 142 and a worm gear 143, and the pinion gear 141 is fixed to the worm wheel 142. The worm gear 143 is fixed to the motor shaft 151 of the electric motor 15.

The electric motor 15 generates torque by the motor current supplied by the steering controller 18 and rotates the worm wheel 142 and the pinion gear 141 via the worm gear 143. As the pinion gear 141 rotates, the rack shaft 11 moves axially forward and backward over a predetermined travel range along the vehicle width direction, and the left and right steering wheels 19 are steered. The rack shaft 11 can move from the neutral position when the steering angle is zero to the right and left sides of the vehicle in the vehicle width direction. In FIG. 1, a range R1 in which the rack shaft 11 can move in the vehicle width direction is indicated by both arrows.

FIG. 2 shows a cross-sectional view of the steering device 1 taken along the line A-A in FIG. 1. The stroke sensor 10 consists of a detection target (i.e., an object to be detected) 110 fixed to the rack shaft 11, a rack housing 2, a substrate 3 as a detector to detect the position of the rack shaft 11 relative to the rack housing 2, a metal plate 101 arranged parallel to the substrate 3, a support member 4 that supports the substrate 3 against the rack housing 2, a seal member 5 attached to the support member 4, a sealing member 6 sealing the substrate 3, a power supply unit 71 and a calculation unit 72 (see FIG. 1). The power supply unit 71 and the calculation unit 72 are connected to the substrate 3 by a cable 73 with a connector 731 at one end, as shown in FIG. 1. The substrate 3, metal plate 101, support member 4, seal member 5, and sealing member 6 constitute a detection unit 100 in the stroke sensor 10.

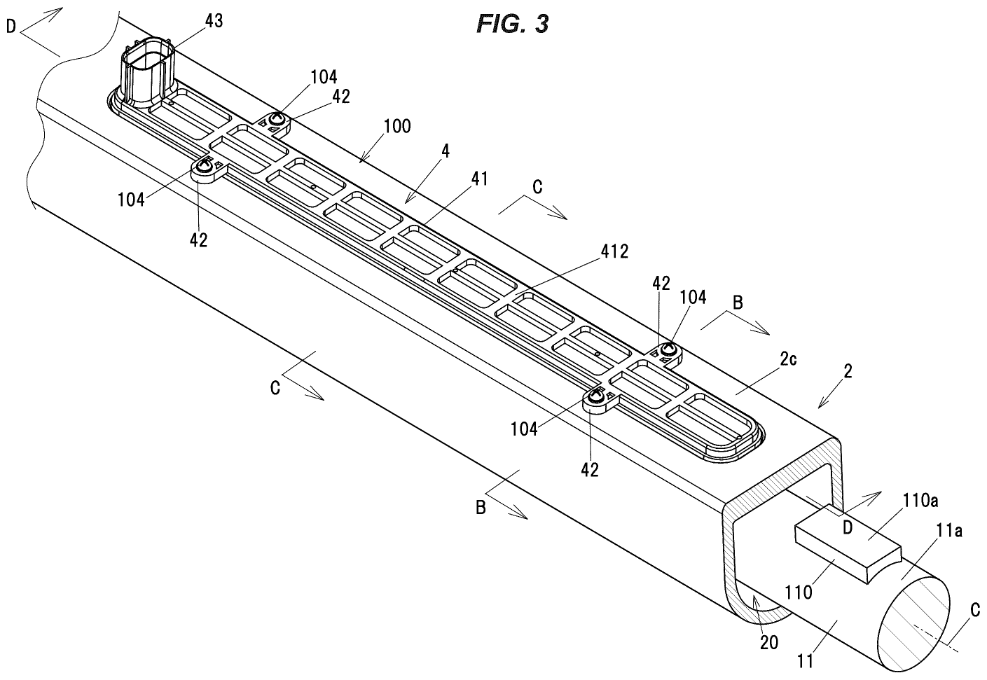

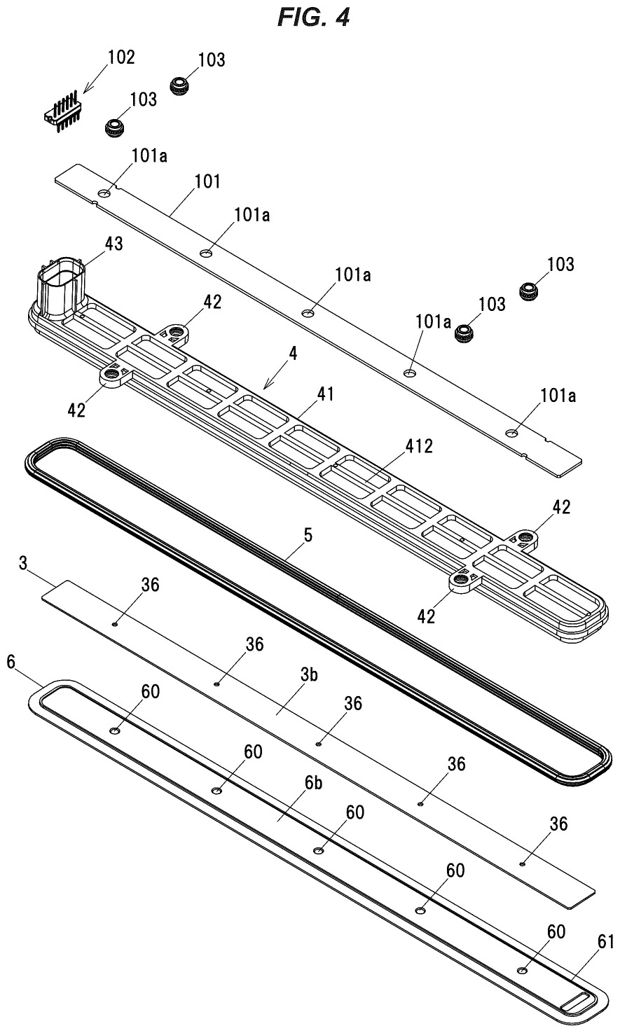

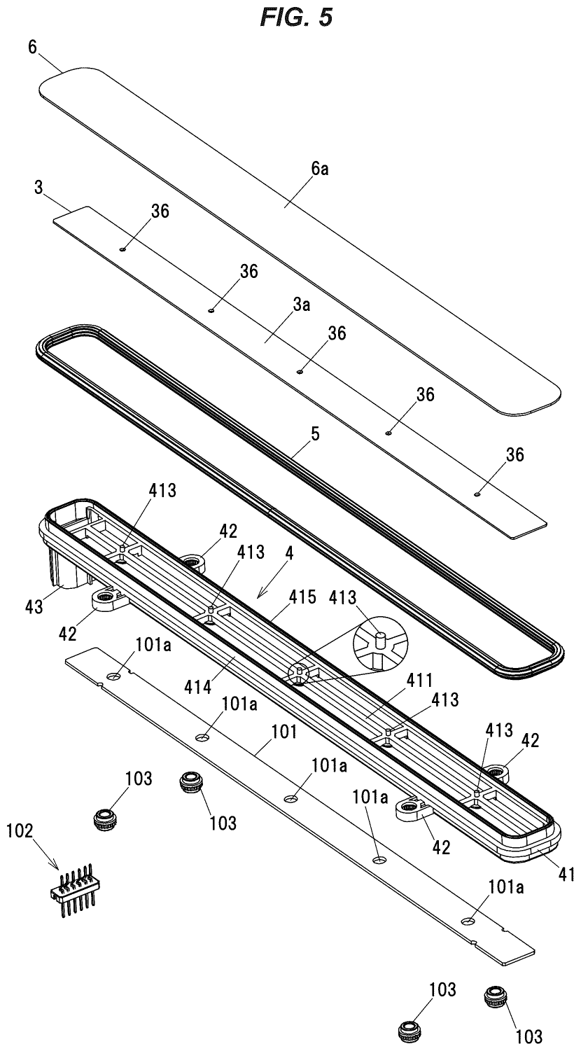

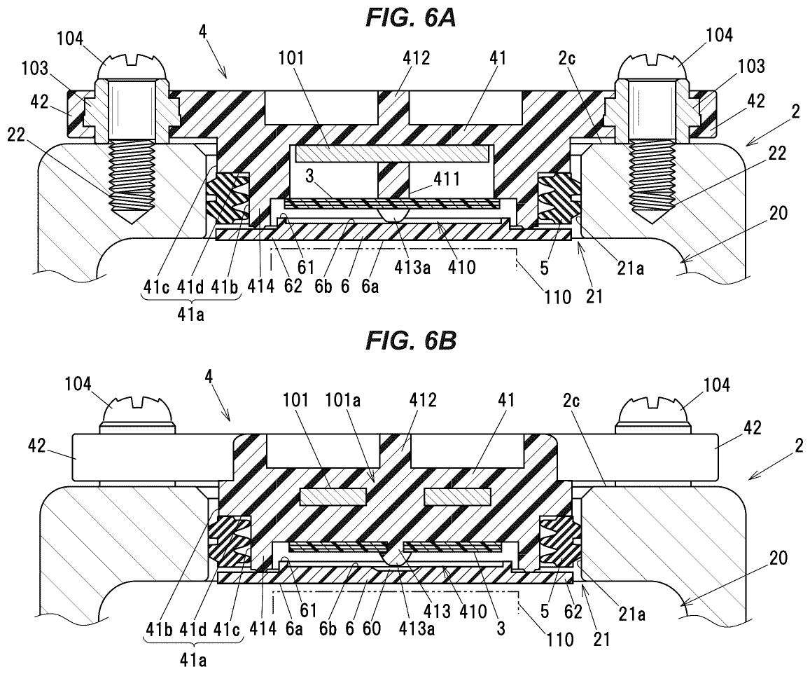

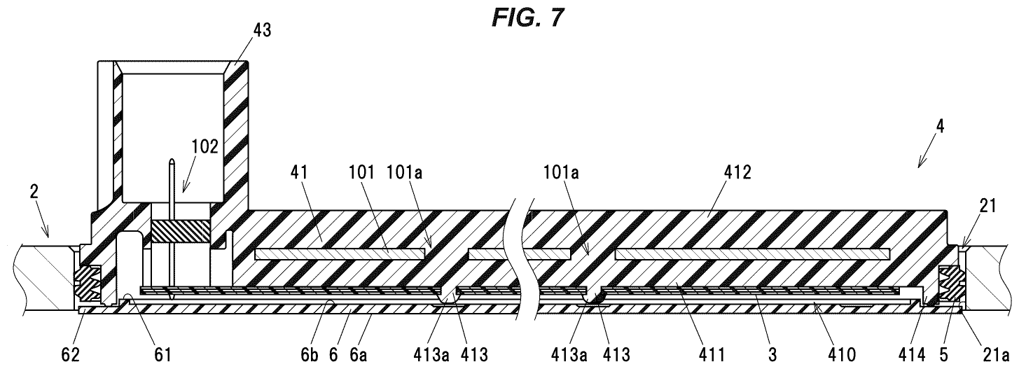

FIG. 3 is a perspective view of the detection unit 100, the rack shaft 11, and the detection target 110 attached to the rack housing 2. FIG. 4 and FIG. 5 are exploded perspective views of the detection unit 100. FIG. 6A and FIG. 6B are cross-sectional views taken along the lines B-B and C-C in FIG. 3 respectively. FIG. 7 is a cross-sectional view taken along the line D-D in FIG. 3.

The rack housing 2 is made of die-cast aluminum alloy and has a housing hole 20 that accommodates the rack shaft 11. The rack housing 2 also has a through-hole 21 that penetrates the rack housing between inner and outer circumferential surfaces along the radial direction of the rack shaft 11. The through-hole 21 penetrates the rack housing 2 between an inner circumferential surface 2a and an outer circumferential surface 2b of the housing hole 20. The outer circumferential surface 2b of the rack housing 2 has a portion thereof as a flat mounting surface 2c for mounting the support member 4. The direction of penetration of the through-hole 21 is perpendicular to the mounting surface 2c and the central axis C of the rack housing 2.

The rack shaft 11 is a shaft-shaped member made of steel, such as carbon steel, and the detection target 110 is attached to the outer circumference surface 11a of the rack shaft 11, for example by welding. The detection target 110 is made of a material with a higher magnetic permeability than that of the rack shaft 11 or a material with a higher electrical conductivity than that of the rack shaft 11. When a material with higher magnetic permeability than that of the rack shaft 11 is used as the material of the detection target 110, it is desirable to use a magnetic material such as ferrite, which has high electrical resistance and is less likely to generate eddy currents. When a material with higher conductivity than that of the rack shaft 11 is used for the detection target 110, a metal mainly composed of aluminum or copper, for example, can be used as the material. The detection target 110 may be formed as an integrated part of the rack shaft 11.

The stroke sensor 10 detects the position of the rack shaft 11 by the position of the detection target 110. The detection target 110 is mounted in a position facing the detection unit 100 over the entire range R₁ in which the rack shaft 11 can move in the vehicle width direction, but in FIG. 3, the detection target 110 which normally faces the detection unit 100 is in a displaced location for illustrative purposes. The surface 110a of the detection target 110, facing the detection unit 100, is flat. In this embodiment, the position of the detection target 110 is detected by the substrate 3 as a detector, using the magnetic action of the detection target 110. Next, the composition of the substrate 3 will be described.

As shown in FIG. 2, the substrate 3 has four layers, a first wiring layer 301, a second wiring layer 302, a third wiring layer 303, and a fourth wiring layer 304 in this order from the front surface 3a on the detection target 110 side to the back surface 3b. A substrate material 30 made of a dielectric such as FR4 (glass fiber soaked into epoxy resin and thermoset) is placed between the first wiring layer 301 and the second wiring layer 302, between the second wiring layer 302 and the third wiring layer 303, and between the third wiring layer 303 and the fourth wiring layer 304. The first wiring layer 301 and the fourth wiring layer 304, which are the outer layers, are covered with a resist film 300 having electrical insulation properties. Wiring patterns are configured in the first wiring layer 301, the second wiring layer 302, the third wiring layer 303, and the fourth wiring layer 304, respectively, and these wiring patterns of the layers are connected by a via 35 at multiple locations on the substrate 3.

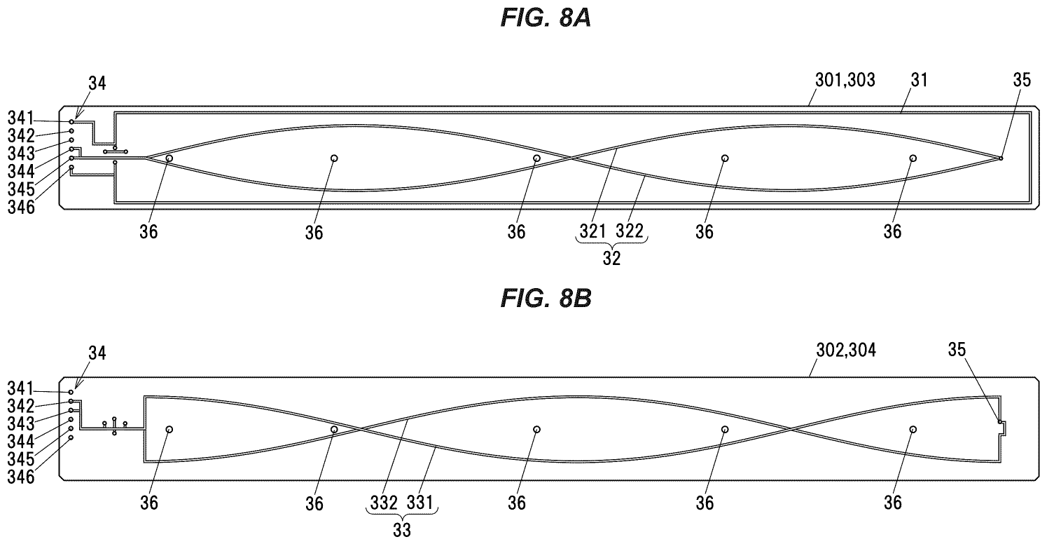

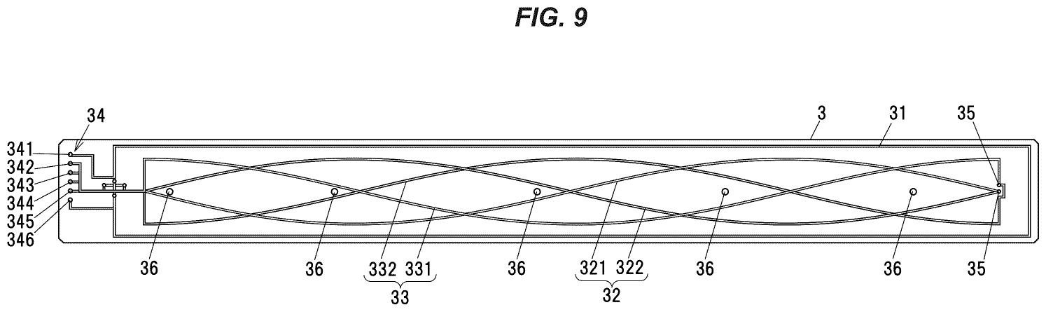

FIG. 8A is a plan view showing an example of the wiring patterns of the first wiring layer 301 and the third wiring layer 303 of the substrate 3. FIG. 8B is a plan view showing an example of the wiring patterns of the second wiring layer 302 and the fourth wiring layer 304 of the substrate 3. FIG. 9 is a plan view showing the wiring patterns of the first wiring layer 301, the second wiring layer 302, the third wiring layer 303, and the fourth wiring layer 304 of the substrate 3, superimposed on one another. In FIG. 8A, FIG. 8B, and FIG. 9, the wiring patterns of the third wiring layer 303 and the fourth wiring layer 304 are shown in light colors. In FIG. 8A, FIG. 8B, and FIG. 9, the dimensions in the width direction (vertical direction in the drawing) relative to the dimensions in the longitudinal direction (horizontal direction in the drawing) of the substrate 3 are shown enlarged.

The substrate 3 has an excitation coil 31 that generates a magnetic field, and a first detection coil 32 and a second detection coil 33 that detect the magnetic field generated by the excitation coil 31. The excitation coil 31 is formed in the first wiring layer 301 and the third wiring layer 303 along the perimeter of the substrate 3. The first detection coil 32 is formed in the first wiring layer 301 and the third wiring layer 303. The second detection coil 33 is formed in the second wiring layer 302 and the fourth wiring layer 304. At one end of the substrate 3 in the longitudinal direction, a through-hole group 34 comprising a plurality of through-holes 341 to 346 is provided to be connected to a connector terminal 102 (see FIG. 4 and FIG. 5) for connecting the power supply unit 71 and the calculation unit 72 by a cable 73 and a connector 731 (see FIG. 1).

The first detection coil 32 comprises a pair of curved portions 321, 322 whose shape as viewed from the front surface 3a side of the substrate 3 has a sine waveform shape. The second detection coil 33 comprises a pair of curved portions 331, 332 whose shape as viewed from the front surface 3a side of the substrate 3 has a cosine waveform shape. The excitation coil 31, the first detection coil 32, and the second detection coil 33 are formed in a loop shape each, with their beginnings and ends connected to the through-holes 341 to 346 of the through-hole group 34. A pair of curved portions 321, 322 of the first detection coil 32 are connected by the via 35 at the other end in the longitudinal direction of the substrate 3. The pair of curved portions 331, 332 of the second detection coil 33 are connected by the via 35 at the other end in the longitudinal direction of the substrate 3.

The excitation coil 31 generates an alternating magnetic field in a direction perpendicular to the substrate 3 by means of a high-frequency current supplied from the power supply unit 71 via the cable 73. The magnetic flux of the AC magnetic field generated by the excitation coil 31 is also chained to the detection target 110. The magnetic flux chained to the detection target 110 affects the intensity distribution of the magnetic flux on the substrate 3. When the detection target 110 is made of a high permeability material, the magnetic flux is concentrated on the detection target 110, resulting in a higher magnetic flux density in the area corresponding to the detection target 110. If the detection target 110 is made of a high conductivity material, the eddy currents generated in the detection target 110 reduce the magnetic flux density in the area corresponding to the detection target 110.

The spacing of the pair of curved portions 321, 322 of the first detection coil 32 and that of the pair of curved portions 331, 332 of the second detection coil 33 varies in the width direction of the substrate 3. Thus, the intensity of the magnetic field detected by the first detection coil 32 and the second detection coil 33 varies according to the positions of the rack shaft 11 and the detection target 110.

The first detection coil 32 and the second detection coil 33 output an output signal(s), which is the voltage induced by the AC magnetic field generated by the excitation coil 31, to the calculation unit 72 via the cable 73. The calculation unit 72 calculates the position of the detection target 110 based on the output signal(s) and transmits the calculation results to the steering controller 18. The magnitude of the voltage induced in the first detection coil 32 and the second detection coil 33 varies within a range of less than one cycle while the rack shaft 11 moves from the moving end on one side of the axial direction to the moving end on the other side of the axial direction. Due to the difference in the shape of the first detection coil 32 and the second detection coil 33, the phase of magnitude change is different by 90° in the voltage induced in the first detection coil 32 and the second detection coil 33 when the rack shaft 11 moves. Therefore, the stroke sensor 10 can detect the absolute position of the rack shaft 11 over the entire range R1 in which the rack shaft 11 is movable in the axial direction.

In addition, a plurality of mounting holes 36 for fixing the substrate 3 to the support member 4 are formed through the front surface 3a and the back surface 3b. Each of the mounting holes 36 is formed at the center in the width direction of the substrate 3 in a position that does not overlap the wiring patterns of the excitation coil 31, the first detection coil 32, and the second detection coil 33.

The metal plate 101 is made of iron, for example, and is ferromagnetic and conductive. The metal plate 101 is positioned parallel to the substrate 3 to enhance the magnetic coupling between the excitation coil 31, the first detection coil 32 and the second detection coil 33, and to suppress the influence of external electromagnetic waves. A plurality of mounting holes 101a are formed in the metal plate 101. Each of the mounting holes 101a penetrates through the metal plate 101 in the thickness direction.

The support member 4 is made of electrically insulating resin and has in one body a support portion 41 that supports the substrate 3 and the metal plate 101, a fixing portion 42 that is fixed to the rack housing 2, and a connector holding portion 43 that holds the connector 731. In the present embodiment, four fixing portions 42 are provided in the support member 4, and a metal collar 103 is formed by in-mold at each of the fixing portions 42. The fixing portions 42 are fixed to the rack housing 2 by means of bolts 104 (see FIG. 3 and FIG. 6) inserted into the collars 103 and screwed into the bolt holes 22 formed in the rack housing 2.

The support portion 41 is at least partially disposed in the through-hole 21 of the rack housing 2. The seal member 5 is in clastic contact with the outer surface 41a of the support portion 41 and the inner surface 21a of the through-hole 21. Hereinafter, the rack shaft 11 side in the through-hole 21 is referred to as an “inner side (lower side)” and the opposite side is referred to as an “outer side (upper side).” The substrate 3 is positioned at the inner side in the through-hole 21, deeper than the metal plate 101.

The metal plate 101 is in-mold molded into the support portion 41 of the support member 4. Resin of the support member 4 enters the plurality of mounting holes 101a in the metal plate 101 during the molding of the support member 4. An inner rib 411 is formed on the inner side of the through-hole 21 deeper than the metal plate 101 in the support portion 41. An outer rib 412 is formed on the outer side (upper side) of the through-hole 21 higher than the metal plate 101 in the support portion 41. The inner ribs 411 and the outer rib 412 contribute to weight reduction and rigidity increase of the support member 4. The surface of the metal plate 101 facing toward the inner side of the through-hole 21 is exposed through the gap of the inner rib 411, but the surface of the metal plate 101 facing toward the outer side (upper side) of the through-hole 21, is covered by the resin of the support member 4 for rust prevention and waterproofing, and is not exposed to the outside.

The substrate 3 is supported by the end portion on the rack shaft 11 side in the support portion 41. Specifically, the back surface 3b of the substrate 3 is in contact with the inner rib 411, and the substrate 3 is supported by a plurality of support projections 413 protruding from the inner rib 411 to the inner side of the through-hole 21. In the state before the substrate 3 is attached to the support member 4, each of the support projections 413 is cylindrical as shown in FIG. 5. When attaching the substrate 3 to the support member 4, insert each of the plurality of support projections 413 into the plurality of mounting holes 36 of the substrate 3, then heat the tip of the support projections 413 while pressing the portion melted by heating onto the front surface 3a of the substrate 3 to form a disk-shaped mooring portion 413a (see FIG. 6). With this mooring portion 413a, the substrate 3 is stopped from slipping out of the support projection 413 and is supported by the support portion 41. The support portion 41 has a frame portion 414 surrounding the substrate 3.

The sealing member 6, like the support member 4, is made of electrically insulating resin, and the substrate 3 is hermetically sealed between the sealing member 6 and the support portion 41 of the support member 4. In other words, a housing space 410 that houses the substrate 3 is hermetically sealed by the sealing member 6. This deters, for example, condensation droplets from adhering to the substrate 3, when water vapor enters the rack housing 2 through the breathing valve 202. In the present embodiment, the support member 4 and the sealing member 6 are joined by laser welding.

The sealing member 6 has a detection target-facing surface 6a facing the detection target 110, which is formed in a flat shape. A substrate-facing surface 6b of the scaling member 6, which faces the substrate 3, has a plurality of recesses 60 to prevent interference with the mooring portion 413a of the support projection 413, as shown in FIG. 4 and FIG. 6B. The sealing member 6 has an annular protrusion 61 that is positioned inside the frame portion 414 of the support member 4. The annular protrusion 61 controls misalignment of the sealing member 6 with respect to the support member 4 when laser welding is performed. The outer portion of the annular protrusion 61 in the sealing member 6 is hereinafter referred to as an “outer edge portion 62.”

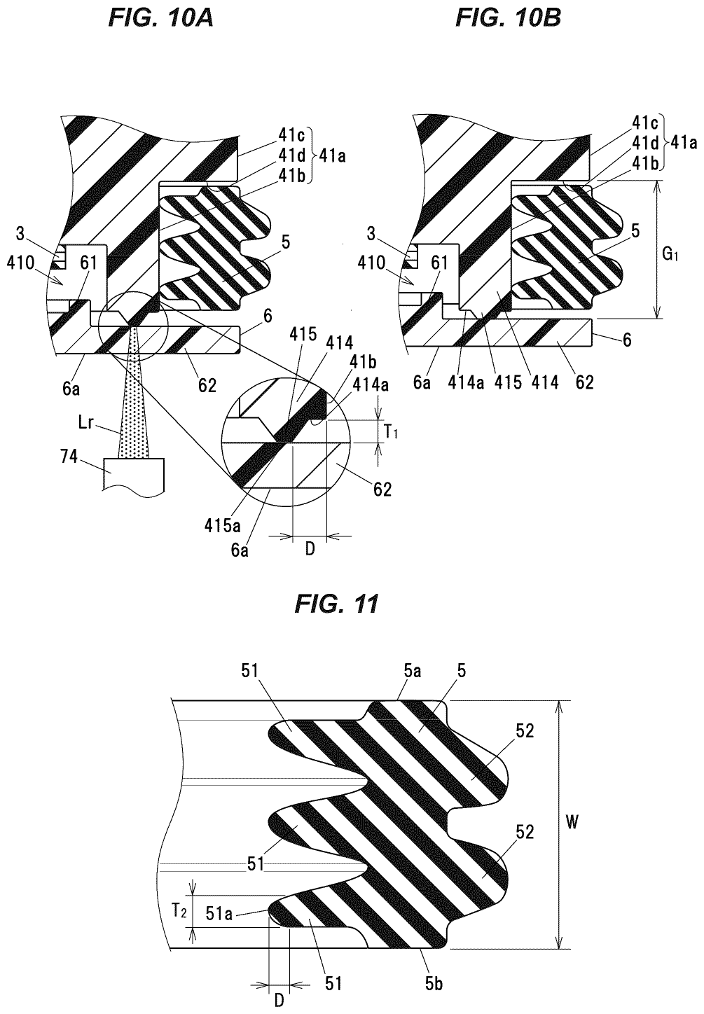

FIG. 10A and FIG. 10B show the conditions before and after laser welding in the frame portion 414 of the support portion 41 in the support member 4 and in the periphery of the seal member 5. The frame portion 414 has an edge surface 414a located on the inner side of the through-hole 21 deeper than the substrate 3. Inside the frame portion 414, the housing space 410 is formed to accommodate the substrate 3. The support portion 41 has a protrusion 415 protruding from the edge surface 414a of the frame portion 414 to the further inner side of the through-hole 21. The frame portion 414 and the protrusion 415 are formed in an annular shape to surround the substrate 3.

When performing laser welding, as shown in FIG. 10A, the laser beam Lr is irradiated from the detection target-facing surface 6a of the sealing member 6, while pressing the outer edge portion 62 of the sealing member 6 against a tip surface 415a of the protrusion 415 of the support member 4. The laser beam Lr penetrates the outer edge portion 62 of the sealing member 6 and strikes the tip surface 415a of the protrusion 415, dissolving the protrusion 415 and a part of the outer edge portion 62 of the scaling member 6 in contact with the protrusion 415. In other words, in the present embodiment, the sealing member 6 is made of light-transmissive resin that transmits the laser beam Lr, and the support member 4 is made of light-absorbing resin that absorbs the laser beam Lr.

In this laser welding, the protrusion 415 of the support member 4 and the outer edge portion 62 of the sealing member 6 are joined all around by the relative movement of the support member 4 and the sealing member 6 to the laser torch 74. When the resin dissolved by the laser beam Lr solidifies, the support member 4 and the sealing member 6 are welded together at the solidified portions. The height of the protrusions 415 after laser welding becomes shorter than the height of the protrusions 415 before laser welding, as shown in FIG. 10B.

In order to ensure laser welding, it is desirable that the support member 4 and sealing member 6 be made of the same type of resin. For example, if the support member 4 is made of nylon 66, it is desirable that the sealing member 6 be made of nylon 66 as well. If the support member 4 is made of PBT (polybutylene terephthalate), it is desirable that the sealing member 6 be made of PBT as well. The support member 4 can be made light absorbent, for example, by blending carbon black.

The outer surface 41a of the support portion 41 of the support member 4 has an elastic contact surface 41b with which the seal member 5 is in clastic contact, an opposing surface 41c that faces the inner surface 21a of the through-hole 21 of the rack housing 2 at a position closer to the inner surface 21a of the through-hole 21 than the elastic contact surface 41b, and a step surface 41d between the elastic contact surface 41b and the opposing surface 41c. The step surface 41d is perpendicular to the elastic contact surface 41b and the opposing surface 41c and is oriented toward the inner side of the through-hole 21. The seal member 5 is disposed between the step surface 41d and the outer edge portion 62 of the sealing member 6, and is held from falling from the support portion 41 by the outer edge portion 62 of the sealing member 6.

FIG. 11 is a cross-sectional view of the seal member 5 alone in its natural state without any external force acting on it. The seal member 5 made of silicone rubber, for example, is attached to the outer circumference of the support portion 41 of the support member 4, and is placed in the through-hole 21 of the rack housing 2. The seal member 5 is annular around the outer circumference of the support portion 41 and has a plurality of inner lips 51 and a plurality of outer lips 52. The respective tips of the plurality of inner lips 51 and the plurality of outer lips 52 are rounded. When the support portion 41 is placed in the through-hole 21 of the rack housing 2, the plurality of inner lips 51 are in clastic contact with the elastic contact surface 41b of the support portion 41 and the plurality of outer lips 52 are in elastic contact with the inner surface 21a of the through-hole 21.

In FIG. 11, the dimension in the width direction of the seal member 5 in the natural state is indicated by W. The distance G1 (see FIG. 10B) between the step surface 41d of the support portion 41 and the outer edge portion 62 of the sealing member 6 after laser welding in the penetration direction of the through-hole 21 is larger than the width W of the seal member 5. Therefore, a gap is formed at least one of the following locations: between one side 5a of the seal member 5 and the step surface 41d of the support portion 41, and between the other side 5b of the seal member 5 and the outer edge portion 62 of the sealing member 6. This configuration prevents the seal member 5 from being compressed between the step surface 41d of the support portion 41 and the outer edge portion 62 of the sealing member 6, and prevents the outer edge portion 62 of the sealing member 6 from being separated from the protrusion 415 of the support member 4 by the restoring force of the seal member 5.

In FIG. 10A, the height of the protrusion 415 before laser welding is shown by T1, and the minimum distance between the elastic contact surface 41b of the support portion 41 and the tip surface 415a of the protrusion 415 in the direction perpendicular to the penetration direction of the through-hole 21 is shown by D. In FIG. 11, the thickness of the inner lip 51 of the seal member 5 at the position of the minimum distance D shown in FIG. 10A from the edge 51a of the inner lip 51 which is located closest to the sealing member 6 of the plurality of inner lips 51 of the seal member 5 is shown by T2. T2 is thicker than T1, which prevents the inner lip 51 from being sandwiched between the frame portion 414 of the support portion 41 and the outer edge portion 62 of the scaling member 6 when laser welding is performed.

### Effect of the First Embodiment

According to the first embodiment described above, the seal member 5 prevents the waterproof property of the rack housing 2 from being compromised while the substrate 3, which detects the position of the rack shaft 11, is placed close to the rack shaft 11. Also, since the sealing member 6 seals the substrate 3 between the substrate 3 and the support portion 41 of the support member 4, it is possible to prevent water droplets, etc. caused by water vapor passing through the breathing valve 202 and entering the rack housing 2 from adhering to the substrate 3. In addition, the sealing member 6 can prevent the seal member 5 from slipping out to the inner side of the through-hole 21.

### Second Embodiment

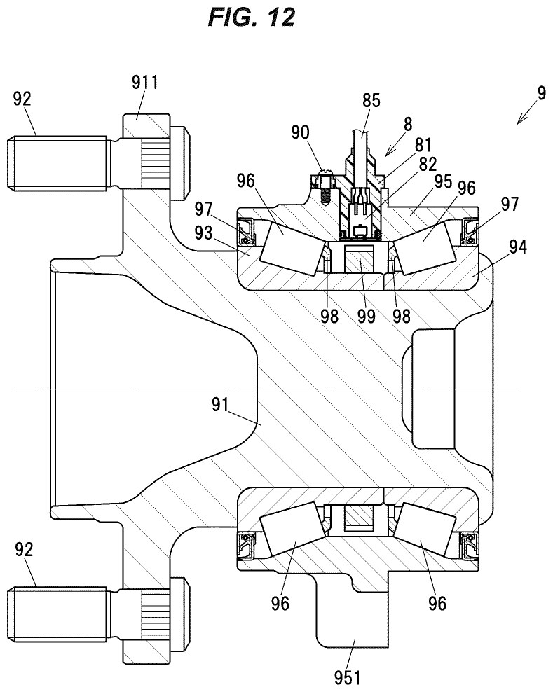

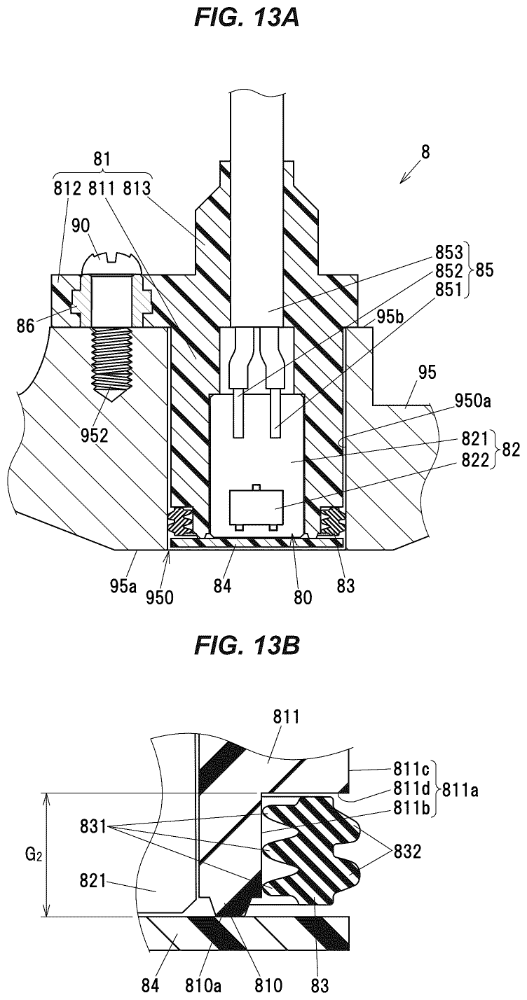

Next, a second embodiment according to the present invention will be described. FIG. 12 is a cross-sectional view of a hub unit 9 equipped with a detection device 8 according to the second embodiment. FIG. 13A is a cross-sectional view of the detection device 8 and its periphery. FIG. 13B is an enlarged partial view of FIG. 13A. The hub unit 9 is attached to a knuckle that constitutes the suspension system of the vehicle and rotatably supports the vehicle wheel. The detection device 8 detects the rotation speed of the vehicle wheel.

The hub unit 9 consists of a hub wheel 91 having a wheel mounting flange 911, a plurality of hub bolts 92 secured to the wheel mounting flange 911 by press fitting, a pair of inner wheels (inner rings) 93, 94 attached to the outer circumference of the hub wheel 91, an outer wheel (outer wheel) 95 disposed on the outer circumference of the pair of inner wheels 93, 94, a plurality of rolling elements 96 and seal members 97 disposed between the pair of inner wheels 93, 94 and the outer wheel 95, a retainer(s) 98 holding the plurality of rolling elements 96, and a pulsar ring 99 attached to the inner wheel 93.

The outer wheel 95 has a fixing flange 951 for fixing to the knuckle. The detection device 8 is partially inserted into a through-hole 950 formed in the outer wheel 95 and fixed to the outer wheel 95 by a bolt 90. The outer wheel 95 is a member to be mounted to which the detection device 8 is attached. The through-hole 950 penetrates the outer wheel 95 in a radial direction and opens on the inner circumference surface 95a and outer circumference surface 95b of the outer wheel 95.

The outer circumference surface of the pulsar ring 99 has a plurality of magnetic poles consisting of N and S poles that are alternating along the circumferential direction. The detection device 8 detects the rotation of the wheel by the change in the magnetic field caused by the rotation of the pulsar ring 99 and outputs the detection signal to the ABS (Antilock Brake System) controller, which is not shown in the figures.

The detection device 8 consists of a support member 81 having a cylindrical portion 811 that is accommodated in the through-hole 950 formed in the outer wheel 95, a detector 82 accommodated in a housing space 80 of the cylindrical portion 811 and supported by the support member 81, a seal member 83 interposed between an inner surface 950a of the through-hole 950 and an outer surface 811a of the cylindrical portion 811 of the support member 81, a sealing member 84 attached to the end of the cylindrical portion 811 to seal the housing space 80, and a cable 85 having a plurality of wires 851, 852 connected to the detector 82. The seal member 83 is held from falling from the cylindrical portion 811 by the sealing member 84.

The support member 81 is a resin molded body formed by injection molding and has the cylindrical portion 811, a flange portion 812 for fixing to the outer wheel 95, and a cable holding portion 813 for holding the cable 85. A metal collar 86 is insert molded into the flange portion 812, and by inserting a bolt 90 into the collar 86 and screwing it into the bolt hole 952 formed in the outer wheel 95, the support member 81 is fixed to the outer wheel 95.

The detector 82 is composed of a substrate 821 on which an unshown wiring pattern is formed and a magnetic field detection element 822 mounted on the substrate 821. The magnetic field detection element 822 detects the magnetic field of the magnetic poles of the pulsar ring 99. The wires 851 and 852 of the cable 85 are connected to the electrodes formed on the substrate 821, for example, by soldering, and transmit a detection signal of the magnetic field detection element 822. The cable 85 has a sheath 853 that accommodates the wires 851, 852. The sheath 853 is in liquid-tight contact with the cable holding portion 813 of the support member 81.

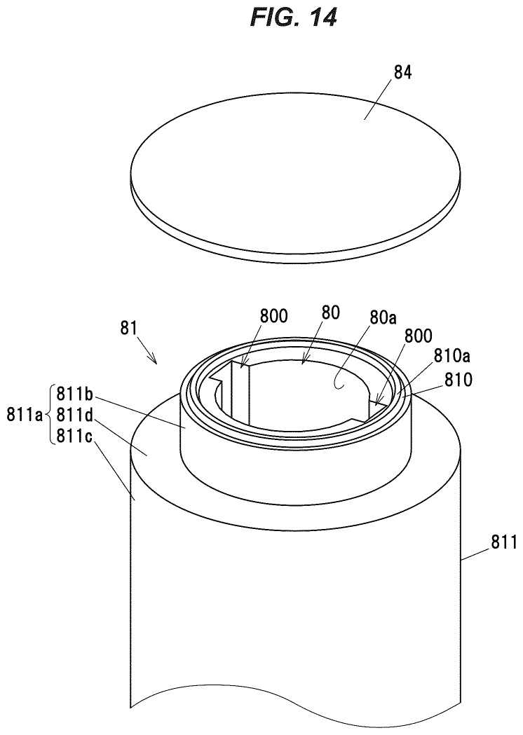

FIG. 14 is a perspective view showing the end of the cylindrical portion 811 of the support member 81 and the sealing member 84. An annular protrusion 810 is provided at the end of the cylindrical portion 811, and the sealing member 84 is welded to the protrusion 810. The sealing member 84 is made of resin and formed in the shape of a disk whose diameter is smaller than the inner diameter of the through-hole 950. As a method of welding the protrusion 810 of the support member 81 and the sealing member 84, laser welding, in which a laser beam transmitted through the sealing member 84 is irradiated onto the tip surface 810a of the protrusion 810, can be used as in the first embodiment. The protrusion 810 is welded to the sealing member 84 over the entire circumference. The sealing member 84 is made of light-transmissive resin, and the support member 81 is made of light-absorbing resin.

A pair of grooves 800 to support the substrate 821 are formed in the cylindrical portion 811. The grooves 800 are formed recessed from the inner surface 80a of the cylindrical portion 811 and extend in the axial direction of the cylindrical portion 811. The substrate 821 is in a rectangular shape where the long side direction is the axial direction of the cylindrical portion 811, and both ends of the short side are accommodated in the pair of grooves 800 and are held inside the grooves 800 by the sealing member 84.

The outer surface 811a of the cylindrical portion 811 has an elastic contact surface 811b which the seal member 83 is in elastic contact with, an opposing surface 811c that faces the inner surface 950a of the through-hole 950 at a position closer to the inner surface 950a of the through-hole 950 than the elastic contact surface 811b, and a step surface 811d between the elastic contact surface 811b and the opposing surface 811c. The seal member 83 has a plurality of inner lips 831 and a plurality of outer lips 832, wherein the plurality of inner lips 831 are in elastic contact with the elastic contact surface 811b and the plurality of outer lips 832 are in elastic contact with the inner surface 950a of the through-hole 950.

In the axial direction of the cylindrical portion 811, the seal member 83 is positioned between the step surface 811d and the sealing member 84. The distance G2 between the step surface 811d and the sealing member 84 in the axial direction of the cylindrical portion 811 is larger than the width of the seal member 83 in the same direction in its natural state. This prevents the seal member 83 from being compressed between the step surface 811d of the cylindrical portion 811 and the sealing member 84, and prevents the sealing member 84 from being separated from the protrusion 810 of the support member 81 by the restoring force of the seal member 83.

### Effects of the Second Embodiment

According to the second embodiment described above, the sealing member 84 can seal the housing space 80 of the detector 82 in the support member 81, preventing the entry of moisture, etc. into the housing space 80. Also, the sealing member 84 can stop the seal member 83 from slipping out of the support member 81, preventing moisture, etc. from entering the inside of the outer wheel 95.

### Summary of the Embodiments

Next, the technical concepts that can be grasped from the first and second embodiments described above will be described with the aid of reference numerals and the like used in the first and second embodiments. However, each reference numeral in the following description does not limit the components in the scope of the claims to the parts, etc. specifically shown in the embodiments.

According to the first feature, a position detection device (stroke sensor 10) for detecting the position of a rack shaft 11 that steers a steering wheel 19 of a vehicle by moving in an axial direction, includes a cylindrical rack housing 2 that accommodates the rack shaft 11; a detector (substrate 3) that detects the position of the rack shaft 11 relative to the rack housing 2; a support member 4 that supports the detector 3 relative to the rack housing 2; and a seal member 5 mounted on the support member 4, wherein the through-hole 21 that penetrates inner and outer surfaces in the radial direction of the rack shaft 11 is formed in the rack housing 2, wherein the support member 4 has a support portion 41 that is disposed in the through-hole 21 and supports the detector 3 and a fixing portion 42 that is fixed to the rack housing 2, and wherein the seal member 5 is in elastic contact with the outer surface 41a of the support portion 41 and the inner surface 21a of the through-hole 21.

According to the second feature, in the position detection device 10 as described in the first feature, the detector 3 is supported at the end on the rack shaft 11 side of the support 41 and is further provided with a sealing member 6 that seals the detector 3 between the sealing member and the support 41.

According to the third feature, in the position detection device 10 as described in the second feature, the support portion 41 has an elastic contact surface 41b which the seal member 5 is in elastic contact with, an opposing surface 41c that faces the inner surface 21a of the through-hole 21 at a position closer to the inner surface 21a of the through-hole 21 than the elastic contact surface 41b, and a step surface 41d between the elastic contact surface 41b and the opposing surface 41c, and the seal member 5 is disposed between the step surface 41d and the sealing member 6 and is prevented from slipping out from the support portion 41 by the sealing member 6.

According to the fourth feature, in the position detection device 10 as described in the third feature, the distance G1 in the penetration direction of the through-hole 21 between the step surface 41d and the sealing member 6 is larger than the width W of the seal member 5 in the same direction in its natural state.

According to the fifth feature, in the position detection device 10 as described in any one of the first to fourth features, the detector 3 having an excitation coil 31 that generates a magnetic field and detection coils 32, 33 that detect the magnetic field generated by the excitation coil 31 is the substrate 3 that is configured so that the intensity of the magnetic field detected by the detection coils 32, 33 changes according to the position of the rack shaft 11, and further comprises a metal plate 101 arranged parallel to the substrate 3 supported by the support member 4.

According to the sixth feature, a detection device 8 includes a support member 81 having a cylindrical portion 811 which is accommodated in a through-hole 950 formed through an attachment member (outer wheel 95), a detector 82 accommodated in a housing space 80 of the cylindrical portion 811 and supported by the support member 81, and a seal member 83 interposed between an inner surface 950a of the through-hole 950 and an outer surface 811a of the support member 81, and a sealing member 84 attached to the end of the cylindrical portion 811 and sealing the housing space 80, wherein the sealing member 84 prevents the seal member 83 from slipping out of the cylindrical portion 811.

According to the seventh feature, in the detection device 8 as described by the sixth feature, the cylindrical portion 811 has an elastic contact surface 811b that the seal member 83 is in elastic contact with, an opposing surface 811c that faces the inner surface 950a of the through-hole 950 at a position closer to the inner surface 950a of the through-hole 950 than the contact surface 811b, and a step surface 811d between the contact surface 811b and the opposing surface 811c, and the seal member 83 is disposed between the step surface 811d and the sealing member 84.

According to the eighth feature, in the detection device 8 as described by the seventh feature, the distance G2 between the step surface 811d and the sealing member 84 in the axial direction of the cylindrical portion 811 is larger than the width of the seal member 83 in the same direction in the natural state.

That is all for the description of the first and second embodiments of the present invention. The first and second embodiments described above do not limit the invention according to the scope of claims. It should also be noted that not all of the combinations of features described in the first and second embodiments are essential to the means for solving the problems of the invention. In addition, the invention can be implemented with appropriate modifications without departing from the scope and spirit of the invention. For example, the following modifications are possible.

In the first and second embodiments above, the case in which the sealing members 6 and 84 are welded to the support members 4 and 81 by laser welding is described, but not limited to this, these may be welded, for example, by ultrasonic welding. In the first embodiment above, the first detection coil 32 and the second detection coil 33 of the substrate 3 detect magnetic fields as detectors, and in the second embodiment above, the magnetic field detection element 822 of the detector 82 detects magnetic fields. However, the physical quantity detected by the detector is not limited to magnetic fields, but it may be, for example, temperature, pressure, or acceleration. Furthermore, in the second embodiment, the case in which the detection device 8 is applied to the hub unit 9 is described, but the application of the detection device 8 is not limited to this, but it can be applied to various devices and equipment.

1. A position detection device for detecting a position of a rack shaft that steers a steering wheel of a vehicle by moving in an axial direction, comprising:
a cylindrical rack housing that houses the rack shaft;
a detector that detects the position of the rack shaft relative to the rack housing;
a support member that supports the detector relative to the rack housing; and
a seal member attached to the support member,
wherein the rack housing has a through-hole that penetrates between the inner and outer circumference surfaces along a radial direction of the rack shaft,
wherein the support member has a support portion that is positioned in the through-hole to support the detector and a fixing portion that is fixed to the rack housing, and
wherein the seal member is in elastic contact with an outer surface of the support portion and an inner surface of the through-hole.

2. The position detection device, according to claim 1,
wherein the detector is supported at an end on a rack shaft side of the support portion, and
wherein a sealing member is further provided for sealing the detector between the sealing member and the support portion.

3. The position detection device, according to claim 2,
wherein the support portion has an elastic contact surface which the seal member is in elastic contact with, an opposing surface that faces the inner surface of the through-hole at a position closer to the inner surface of the through-hole than the elastic contact surface, and a step surface between the elastic contact surface and the opposing surface,
wherein the seal member is placed between the step surface and the sealing member, and
wherein the sealing member prevents the seal member from slipping out of the support portion.

4. The position detection device, according to claim 3,
wherein a distance between the step surface and the sealing member in a penetration direction of the through-hole is larger than a width of the seal member in a same direction in its natural state.

5. The position detection device according to claim 1, wherein the detector is a substrate having an excitation coil that generates a magnetic field and a detection coil that detects the magnetic field generated by the excitation coil, which is configured so that an intensity of the magnetic field detected by the detection coil changes according to the position of the rack shaft, and
wherein a metal plate is further provided in parallel to the substrate supported by the support member.

6. A detection device, comprising:
a support member having a cylindrical portion that is accommodated in a through-hole formed through a member to be mounted;
a detector housed in a housing space of the cylindrical portion and supported by the support member,
a seal member interposed between an inner surface of the through-hole and an outer surface of the support member; and
a sealing member attached to an end of the cylindrical portion to seal the housing space, wherein the sealing member prevents the seal member from slipping out of the cylindrical portion.

7. The detection device, according to claim 6, wherein the cylindrical portion has an elastic contact surface which the seal member is in elastic contact with, an opposing surface that faces the inner surface of the through-hole at a position closer to the inner surface of the through-hole than the elastic contact surface, and a step surface between the elastic contact surface and the opposing surface, and
wherein the seal member is positioned between the step surface and the sealing member.

8. The detection device, according to claim 7, wherein a distance between the step surface and the sealing member in an axial direction of the cylindrical portion is larger than a width of the seal member in a same direction in its natural state.
